(19) United States
(12) Patent Application Publication
(10) Pub. No.: US 2025/0144600 A1
(43) Pub. Date: May 8, 2025

(54) A CARBON DIOXIDE CAPTURE STRUCTURE AND A METHOD OF MAKING THEREOF, AND A METHOD FOR REMOVING CARBON DIOXIDE FROM A FLUID

(71) Applicant: VITO NV, Mol (BE)

(72) Inventors: Ben SUTENS, Mol (BE); Marleen ROMBOUTS, Mol (BE); Yoran Michel Marc Arielle DE VOS, Mol (BE)

(21) Appl. No.: 18/832,665

(22) PCT Filed: Mar. 27, 2023
(86) PCT No.: PCT/EP2023/057814

§ 371 Date: Jul. 24, 2024

(30) Foreign Application Priority Data
Mar. 25, 2022 (EP) 22164485.9

(51) Int. Cl. B01J 20/30; B01D 53/62; B01D 53/81; B01D 53/96; B01J 20/04; B01J 20/20; B01J 20/28; B01J 20/34; B33Y 10/00; B33Y 70/10; B33Y 80/00

(52) U.S. Cl. CPC B01J 20/3007; B01D 53/62; B01D 53/81; B01D 53/96; B01J 20/043; B01J 20/20; B01J 20/2803; B01J 20/28045; B01J 20/3042; B01J 20/3078; B01J 20/3416; B01J 20/3458; B33Y 10/00; B33Y 70/10; B33Y 80/00; B01D 2251/306; B01D 2251/606; B01D 2253/102; B01D 2257/504; B01D 2259/40086

(57) ABSTRACT

A carbon dioxide capture structure having a monolithic three-dimensional shape, the structure being porous with interconnected pores which are accessible from an exterior side of the structure. The structure is made of a building material including a first material and a second material. The first material is a sorbent material (e.g. functionalizable for carbon dioxide adsorption). The second material is a binder material including potassium silicate. The present disclosure also relates to a method of making the carbon dioxide structure and a method for removing carbon dioxide from a gas or fluid mixture.

### FIELD

The present disclosure relates to a carbon dioxide capture structure having a monolithic three-dimensional shape. The present disclosure also relates a method of making such a carbon dioxide capture structure. Furthermore, the present disclosure relates to a method for removing carbon dioxide from a gas or fluid mixture. Additionally, the present disclosure relates to a system for removing carbon dioxide from a gas or fluid mixture. Further, the present disclosure relates to a packed bed comprising a plurality of carbon dioxide capture structures.

### BACKGROUND

The emission of greenhouse gases into atmosphere, especially carbon dioxide, is a worldwide acknowledged problem. Throughout the last years, a significant increase in CO₂ emission has been observed which is predominantly caused by human activities including industry, transportation and the use of fossil fuels as an energy source. Since CO₂ emission continues to steadily increase every year, it is considered as the primary driver of climate change and one of the most pressing challenges. Some processes may help reduce the ecological impact of CO₂ by capturing it preventively as well as using it as a building block for fuels, polymers and other valuable chemicals, also known as Carbon Capture, Utilization and Storage (CCUS). CO₂ could be captured directly out of air (Direct Air Capture) as well as out of industrial flue gases.

Typically, CO₂ capture processes involve the use of liquid amine solutions. However, these amines may have several drawbacks including high energy consumption during regeneration, thermal and oxidative solvent degradation and evaporation, as well as formation of corrosion products. Due to these disadvantages, more and more interest is growing towards the separation and adsorption of CO₂ by means of solid porous materials, which show a high selectivity for CO₂ while being able to reduce the energy consumption and amount of wastewater significantly.

Three dimensional monolithic porous structures comprising adsorbent particles gained increasing interest as an alternative to conventional sorption systems like packed beds of pellets, beads, or granules. An effective design of the monolith's geometric structure permits improving its overall performance in terms of pressure drop and mass and heat transfer characteristics. Traditionally, monoliths are fabricated using an extrusion process.

Extrusion-based additive manufacturing methods wherein a building material is extruded through a nozzle in the form of filaments, have been developed for the fabrication of three-dimensional monolithic porous structures of widely varying sizes. A desired arrangement of filaments can be obtained by relative movement of the nozzle with respect to a print surface during filament deposition. Filaments are positioned relative to one another according to a predetermined pattern, thereby providing a structure with desired properties. The lay-down pattern is determined by the print path and has major impact on the properties of the printed structure. In this way, complex geometries and porous structures can be obtained with a fully interconnected network of pores which are of particular interest for application as a sorbent.

Monolithic adsorbents comprising zeolites or metal-organic frameworks (MOFs) have been considered as adsorbent structures for CO₂ capture. For example, cordierite monoliths wash-coated with a thin layer of 13X zeolite have been investigated experimentally and numerically for CO₂ capture from flue gas. Although the mechanical strength of these coated substrates was found to be reasonably good, the ceramic support did not contribute to CO₂ adsorption, hence limiting the active adsorbent amount per unit volume.

US2019083954 discloses a CO₂ capture material effective at capturing CO₂ from a gas or mixture of gases comprising about 5% or less CO₂. The CO₂ capture material may include at least 80 wt. % of a 13X or a 5A zeolite material and from about 7 to 15 wt. % of one or more binders, typically bentonite clay, methyl cellulose, and any combination thereof. The method for producing such a CO₂ capture material may include mixing zeolite powder, bentonite clay, a plasticizing organic binder, and a co-binder to obtain a powder mixture, and adding distilled water to the powder mixture to form an aqueous paste. The method may further include depositing filaments of the aqueous paste layer-by-layer, using a 3D-printing apparatus, onto a substrate to produce a 3D-printed zeolite monolith. After the monolithic structures are printed, they may be initially dried at room temperature and then be placed into an oven and heated at 100° C. to remove the rest of water and allow the polymer linker (PVA) and methyl cellulose to quickly build up high strength and avoid skin cracking. After having been oven dried, the monoliths may be calcined at 700° C. to decompose and remove the organic content and enhance the mechanical strength.

U.S. Pat. No. 10,137,428B2 discloses dense silica bound zeolite adsorbent particles having an increased volumetric gas adsorption capacity as compared to clay bound zeolite adsorbent particles, for use in a fixed CO₂ sorption bed. The adsorbent particles comprise zeolite powders with a particle size of 1-10 micron, bound with 5-20 wt. % of a silica binder selected from the group consisting of colloidal silica, silicic acid, alkali metal silicate and combinations thereof. The silica binder slurry comprises 15-50 wt. % of silica. The silica binder is in an aqueous slurry, with a pH adjusted to a pH of 3-8 prior to mixing with the zeolite powder. The adsorbent particles are dried at 120° C., followed by calcination at 600° C.

The use of high calcination temperatures limits the nature of the materials that may be used as a sorbent, it is energetically disadvantageous and may lead to crack formation.

There is a desire to manufacture CO₂ capture structures which can capture CO₂ with higher efficiency and/or reliability in order to improve CO₂ removal. Furthermore, there is a need for CO₂ capture structures made of materials resulting in a higher CO₂ adsorption capacity, preferably having a robust design.

### SUMMARY

The present disclosure provides a method and a system that obviates at least one of the above-mentioned drawbacks.

Additionally or alternatively, the present disclosure provides a carbon dioxide capture structure with a higher carbon dioxide adsorption capacity.

Additionally or alternatively, the present disclosure provides a carbon dioxide capture structure which can more effectively and/or efficiently capture carbon dioxide from a gas or fluid mixture.

Additionally or alternatively, the present disclosure provides for an improved method and system for removing carbon dioxide from a gas or fluid mixture.

Additionally or alternatively, the present disclosure provides a carbon dioxide capture structure with improved mechanical properties and/or robustness.

Additionally or alternatively, the present disclosure provides a carbon dioxide capture structure with reliable adsorption properties, even after successive adsorption/desorption steps.

Thereto, the present disclosure provides a method of making a three-dimensional monolithic carbon dioxide capture structure, the method including:
providing a first material, wherein the first material is a sorbent material comprising a carbon-based sorbent material;
providing a second material, wherein the second material is an inorganic binder material including potassium silicate;
providing a solvent, such as water;
mixing the first material, second material and the solvent to produce a sorbent mixture;
building a monolith three-dimensional porous structure using the sorbent mixture as building material; and
treating the monolith three-dimensional porous structure so as to obtain the carbon dioxide capture product; and
wherein the treating includes drying with a maximum temperature of 150° C.

The presence of a potassium silicate binder can lead to a significantly increased sorption capacity for CO₂. In some examples, the CO₂ adsorption capacity may be increased with a factor up to 5, preferably up to 4 when compared to the carbon-based sorbent material as such. As a result, a porous three-dimensional CO₂ monolithic capture structure, with a high CO₂ sorption capacity can be obtained, with a good dimensional stability, which makes it very suitable for manufacturing processes for building 3D monolith porous structures, such as extrusion and 3D printing. Moreover, improved cycling properties involving repeated carbon dioxide adsorption and desorption, can be obtained. The adsorption capacity may be fully restored in repeated adsorption and desorption cycles.

The presence of a potassium silicate binder can lead to faster kinetics at lower temperatures in comparison with some binder materials such as sodium and lithium silicates.

The three-dimensional monolithic carbon dioxide capture structure can be produced using an energy efficient process. More particularly, lower temperatures may be required in the manufacturing process, resulting in less energy consumption. Therefore, the process of making the carbon dioxide capture structure can be made more cost-effective.

The increased sorption capacity has been observed regardless of the observed reduction of the active surface area of the carbon-based sorbent material, for example due to a loss in meso- and/or micro-porosity. This increased sorption capacity may be attributed to a dual nature of the sorbent structure, wherein the activated carbon sorbent material mainly ensures physical CO₂ adsorption, and the potassium silicate binder mainly adsorbs CO₂ through chemisorption.

Despite a decreased specific surface area and micropore volume of the carbon-based sorbent material, significantly higher sorption capacities were observed in experiments, even after multiple cycles with room temperature regeneration. Active CO₂ adsorption sites require higher temperatures in order to be fully regenerated. The composite material obtained with the method of this invention adsorbs CO₂ by a combination of physisorption in the pores of the activated carbon and chemisorption on the binder material. This chemisorption process most likely involves the conversion of potassium bicarbonate (KHCO₃) to potassium carbonate (K₂CO₃), and their hydrated forms.

The carbon dioxide capture structure can be effectively used for reversible (successive) CO₂ adsorption and desorption cycles. The combination of the first material and second material may provide for a good sorption capacity for carbon dioxide.

Advantageously, the building material with potassium silicate as low-temperature binder is a 3D-printable or extrudable CO₂ material, providing high mechanical strength, good chemical and thermal stability, which is suitable for repeated CO₂ ad- and desorption cycles, and shows an improved total CO₂ sorption capacity.

Other additives, such as for example conventional additives, may be added to the sorbent mixture. The conventional additives may be added prior to, during and/or after the mixing step.

Optionally, the first material and second material have a weight ratio in a range from about 0.8:0.2 to about 0.2:0.8, more preferably from about 0.6:0.4 to about 0.4:0.6 based on dry weight. In some cases, an improved printability was obtained for a ratio between 0.6:0.4 to about 0.4:0.6 based on dry weight. The dry weight may relate to the dry weight of the build material or that of the sorbent structure. Advantageously, although the active surface area may decrease by mixing the sorbent material with potassium silicate binder, experiments indicate that the carbon dioxide adsorption by the structure according to the disclosure is effectively increased. The monolith 3D structure formed by a building material including the first material (cf. sorbent material) and the second material (i.e. potassium silicate binder) can more effectively capture carbon dioxide. The potassium silicate can increase CO₂ sorption capacity and ensure reversible CO₂ adsorption/desorption at moderate temperatures, although other alkali metal silicates may not show reversible CO₂ adsorption/desorption at moderate conditions.

Moreover, the mixture of the first and second materials may be well suited for 3D printing or extrusion for forming a 3D shaped monolith structure. Additionally, an adequate mechanical strength and/or structural stability can be obtained, resulting in a robust structure. Moreover, the stability of structural properties, for example after a large number of adsorption/desorption cycles, may be maintained.

Although the potassium silicate binder itself may have negligible carbon dioxide sorption capacity in bulk form, the CO₂ adsorption capacity obtained by combining the carbon-based sorbent material (first material) and the potassium silicate binder (second material) in the building material can be effectively increased, in some examples by more than 300%, even by more than 400%, and up to 500% compared to the adsorption capacity achievable by the sorbent material alone.

It will be appreciated that the above ratios relate to the carbon dioxide capture structure based on dry weight, i.e. after treatment (cf. drying). Hence, the ratios are indicative of a dry weight percentage. The dry weight may relate to the dry weight of the build material or to the dry weight of the sorbent structure, which are considered equivalent.

In some examples, the building material has 10-80 wt. % of binder material, preferably 20-80 wt. %, preferably 30-70 wt. %, more preferably 40-60 wt. % based on the dry weight. In particular the building material may include less than 50 wt. % of binder material, preferably less than 40 wt. %, more preferably less than 30 wt. %. In some examples, the building material includes 10-50 wt. % of binder material, preferably 20-50 wt. %, more preferably 30-50 wt. %. Within these ranges, the sorption capacity provided by the carbon-based sorbent material remains sufficiently high and a synergistic effect may be observed when combined with the potassium silicate binder material.

Optionally, the sorbent material may besides the carbon-based sorbent material, further comprise at least one further sorbent material such as a zeolite sorbent material, a silica-based sorbent material, a clay (mineral or synthetic) sorbent material, an organic polymer or resin sorbent material, or a metal organic framework sorbent material. The amount of the at least one further sorbent material is preferably limited, preferably to a level of below 25 wt. %, more preferably below 20 wt. %, most preferably to a level below 10 wt. %, with respect to weight of the carbon-based sorbent material, based on dry weight. Most preferably however, the sorbent material exclusively consists of the carbon-based material.

For example, adsorbent materials can be distinguished in three categories, based on the nature of the adsorption process provided: (I) Activated carbon and zeolites, in which adsorption mainly involves physisorption, (II) metal-based adsorbents (e.g. Na₂CO₃, K₂CO₃, CaO, . . . ) and hybrid organic/inorganic sorbents including amine-functionalized inert supports, in which adsorption mainly involves chemisorption and (III) materials such as Metal Organic Frameworks (MOFs) in which adsorption mainly occurs due to both chemisorption and physisorption. Metal-based adsorbents and specifically metal carbonates provide several advantages that make them desirable for carbon capture, including their inexpensiveness, nonvolatility, resistance to degradation and low binding energy with CO₂ enabling an energy-efficient capture process.

The structure according to the disclosure has a 3D monolith shape with interconnected pores/channel. This can have significant benefits compared to conventional sorbents in powder or pelletized form.

Shaping of these adsorbents by 3D-printing (e.g. 3D robocasting) or extrusion typically includes the addition of a binder, which can act as a rheology modifier and provides strength. Addition of several organic and inorganic binders often require the need for a high-temperature thermal treatment in order to remove the organics and obtain a homogenous and strong porous material. This typically leads to a loss in specific surface area, porosity and consequently in CO₂ sorption capacity as the binder does not actively contribute to the sorption process. In order to avoid these challenges, an active low-temperature binder which adsorbs CO₂ and contributes to the total sorption capacity could offer a possible solution and could result in the retainment and even increase of the total capacity. According to the disclosure, the advantageous low-temperature binder includes potassium silicate.

Shaping of sorbent structures comprising activated carbon as the sorbent material is generally performed using: (i) a polymeric resin which is pyrolyzed and activated in a high temperature treatment or (ii) a combination of an organic plasticizing agent, for instance methylcellulose and an inorganic clay binder is subjected to a heat treatment to remove the organic binder to and prevent blocking of the porosity of the sorbent by the binder. The inorganic clay binder remaining in the material after the thermal treatment provides mechanical strength to the structure. However, the clay binder does not contribute to the overall sorption capacity. Therefore the usage of other binders than potassium silicate usually results in a trade-off between mechanical strength and sorption capacity, which implies a certain optimum binder content for the application. Furthermore, calcination at high temperatures usually required for binder materials such as clay may affect the carbon-based sorbent material, it is energetically disadvantageous and may lead to the formation of cracks or breaking of the structure. Furthermore, calcination at elevated temperatures may damage the carbon-based sorbent material, for example by irreversibly inducing chemical changes (e.g. (partial) decomposition, oxidation or pyrolysis of the activated carbon structure) leading to a reduced performance.

Further sorbent materials suitable for use with this invention in combination with the carbon-based sorbent material include inorganic sorbent materials such as various clay materials (e.g. clay minerals), silica, alumina, various zeolites etc. Further sorbent materials suitable for use with this invention in combination with the carbon-based sorbent material may also include organic sorbent materials, such as polymer sorbent materials, resins

Further sorbent materials suitable for use in combination with the carbon-based sorbent material advantageously include amine functionalized sorbent materials having amine groups chemically bound to the sorbent material surface. Optionally, the amine functionalized sorbent material is a non-impregnated material, or in other words the sorbent material is amine functionalized with amine groups chemically bound to the material. The chemical functionalization may result in a higher chemical and/or thermal stability (e.g. less leaching), e.g. at higher temperature and/or in presence of water (e.g. vapor). Additionally or alternatively, the effects of a detrimental shielding of smaller pores by an impregnation layer may be prevented.

It will be appreciated that the term “amine functionalized” is to be understood as having amine groups chemically bound to the sorbent material, instead of impregnating the material and/or providing a coating. For example, a material may be provided which has amine functionalized groups. The material may for instance be a polymer with chemically bound amine groups. The material may also be a silica material to which hydroxy functional groups are bound. Various other materials may also be functionalized with amines.

Suitable amine-functionalized sorbent materials include amine functionalized resins, in particular a crosslinked, macroporous, polystyrene based resin, preferably a benzyl amine-co-polystrene based resin.

Optionally, the further sorbent material comprises a curable resin. Optionally, the sorbent material is a multi-component curable resin.

Optionally, the amine functionalized resin is an ion exchange resin. The ion exchange resin may be a weakly basic ion exchange resin. In some examples, the ion exchange resin is a polystyrene polymer-based resin, which is crosslinked via the use of divinylbenzene, and is functionalized with primary amine groups including benzylamine and wherein the resin is produced by a phthalimide process. The ion exchange resin may be a weakly basic ion exchange resin, or it may be a polystyrene polymer-based resin, which is crosslinked via the use of divinylbenzene, and is functionalized with primary amine groups including benzylamine.

Examples of organic polymers or resin sorbent materials suitable for use with this invention include basic Immobilized Amine Sorbent impregnated with amine functional groups, amines; monoethanolamine; diethanolamine; polyethylenimine (PEI); aminopropyltrimethoxysilane; polyethyleneimine-trimethoxysilane; amide or amine containing polymers including nylon, polyurethane, polyvinylamine, or melamine, ion-exchange resins, for example a benzyl amine-co-polystyrene based ion exchange resin produced by the phthalimide addition process,

Porous silica may for example be produced by hydrolysis of silicon alkoxides in alkali solution or by hydrolysis of sodium silicate in acidic solutions. Silica sorbents synthesized using these methods typically have a specific surface area of 300-600 m²/g. Mesoporous silica's often have a specific surface area of 1000 m²/g or more, they often have an ordered pore structures, tunable over the range 20-100 Å, and are available in a wide range of morphologies such as spheres rods, discs, powders, etc. Examples of commercially available mesoporous silica's include SBA 15, SBA 16, MCM 41, MCM 48, etc. with a wide range of pore geometries (hexagonal, cubic, etc.) and particle morphologies such as discs, spheres, rods, etc.

Zeolites are naturally occurring or industrially produced microporous aluminosilicates also known as “molecular sieves”, and mainly consist of silicon, aluminum, oxygen,

MOFs are generally composed of two major components: a metal ion or cluster of metal ions and an organic molecule called a linker. For this reason, the materials are often referred to as hybrid organic-inorganic materials.

Optionally, the carbon-based sorbent material includes at least one of an activated carbon, activated coke, activated charcoal, activated carbon fibers, biochars or chars. The carbon-based sorbent material may include functional groups capable of chemically adsorbing CO₂.

If the potassium silicate binder is used with first materials comprising a carbon-based sorbent material, an increase in the adsorption capacity can be observed.

The combination of activated carbon, or other carbon-based sorbents, and a potassium silicate binder may provide for significantly increased efficiency in capturing carbon dioxide. For example, activated carbon can be relatively cheap and can provide for a cost-effective carbon dioxide capture structure. In some examples, other carbon-based sorbents are used, such as for instance graphene, graphite, etc.

Activated carbon typically has a rather hydrophobic surface and is more likely to adsorb carbon dioxide than water. Zeolites may have a rather hydrophilic surface, resulting in higher affinity for water, which may affect carbon dioxide adsorption. Hence, in some cases, in particular when the fluid may contain water, the use of a carbon based second material may be preferred.

In some examples, activated carbon sorbents are shaped in monolithic/multi-channel systems by using potassium silicate as low-temperature binder. The porous structure can be manufacture by 3D printing, extrusion, or the like. The structure may for example be a beam-like monolithic structured printed sorbent. The structure according to the disclosure has improved CO₂-capture performance and beneficial required temperature for active-site regeneration. A mechanically stable activated carbon sorbent with increased carbon capture performance can be obtained, even when a room temperature regeneration for example by N₂ purging is applied. Although the CO₂ uptake may slightly drop after several cycles due to incomplete recovery at room temperature, a capacity increase of at least 25% was observed in comparison with the original activated carbon powder in various exemplary experiments.

In various exemplary experiments, an optimization of the CO₂ desorption step was performed by increasing the regeneration temperature up to 150° C. to improve the recovery of the active sorbent. This resulted in a CO₂ uptake of the composite material of 0.76 mmol/g, almost tripling the working capacity of the original activated carbon powder (0.28 mmol/g). An in situ XRD study was carried out to confirm the proposed sorption mechanism, indicating the presence of potassium bicarbonates and confirming the combination of physisorption and chemisorption in the composite.

Although it is preferred that the binder material exclusively consists of potassium silicate, the potassium silicate may contain trace elements selected from one or more of Na, Li, Ca, Mg, Fe and Al silicates.

Further, the binder material may not exclusively consist of potassium silicate, and one or more other organic and/or inorganic binder materials may be present. Suitable other binder materials include alumina, aluminates, aluminosilicates, zeolites, attapulgite, clays for example bentonite clay, calcium compounds etc. In order to minimize the risk to blocking of the pores of the sorbent material and to maintain the synergistic effect observed by the presence of the potassium silicate binder, the amount of other binder materials is advantageously limited to less than 25 wt. % with respect to the amount of binder material contained in the sorbent mixture or the carbon dioxide capture structure.

Optionally, the binder material includes at least 60 wt. %, more preferably at least 75 wt. %, most preferably at least 90 wt. %, in particular at least 95 wt. % or 99 wt. % of potassium silicate, based on the dry weight.

Optionally, the potassium silicate binder used in the method of this invention can be a water-based solution or dispersion or a powder. Optionally, the binder includes oxides and hydroxides of (especially) K and Si with a molar ratio of Si:K between 1:1 and 5:1, more preferably between 2:1 and 3:1. Optionally, the potassium silicate binder can contain impurities of one or more of Na, Li, Ca, Mg, Fe, Al. However, the impurity:K ratio is preferably smaller than 2.5:100, more preferably smaller than 1:100.

In some cases, the additional sorbent material may be functionalized with amine functional groups and may be sensitive for high temperatures. However, advantageously, by employing a potassium silicate binder, the need for such high temperatures can be effectively avoided. Additionally, the potassium silicate binder may increase the mechanical strength of the formed structure when treated at lower temperatures. Treatment of the formed structure at relatively high temperatures, such as for instance higher than 150° C., may advantageously not be required.

Optionally, the three-dimensional monolithic carbon dioxide capture structure comprises multiple parts connected to each other. For example, the structure may have multiple walls and/or filaments connected to each other in order to form a porous structure. The porous structure may contain intra-structure pores, channels and/or openings between the filaments and/or walls. In some examples, the three-dimensional monolithic carbon dioxide capture structure is manufactured by means of filament extrusion (cf. 3D printing, robocasting, micro-extrusion or direct ink writing). However, other manufacturing processes may also be used. For example, the three-dimensional monolithic carbon dioxide capture structure may be formed by extrusion in or through a mold or the like. The carbon dioxide capture structure itself may have various porous 3D shapes, such as for instance a honeycomb structure, a lattice structure, a meshed structure, etc. At least one side of the structure has interconnected pores (e.g. channels) which are accessible from an exterior side of the structure.

Optionally, the monolithic carbon dioxide capture structure is a monolithic structure with structured porosity. For example, the carbon dioxide capture structure may be a honeycomb structure, a meshed 3D structure or a lattice structure.

It will be appreciated that the monolith 3D shaped carbon dioxide capture structure of the disclosure does not encompass pellets, beads or granules. Typically, such elements are used in a packed bed, which can result in high pressure drops, inefficient use of active material and increased attrition. Therefore, monolithic structures show great potential due to a uniform flow pattern resulting in low pressure drop and improved heat- and mass transfer. In contrary to coating of a monolithic inert sorbent, additive manufacturing, 3D-printing, or extrusion of a mixture containing the sorbent material and binder enables the development of an optimal porous structure with a specific design, fitted to the application while showing a high sorbent loading per volume material.

Optionally, the structure comprises a porous arrangement of building material with intra-structure pores.

In some examples, the monolith structure is manufactured by means of a 3D printing process or an extrusion process. The interconnected pores/openings (e.g. channels) of the structure may be accessible from one or more outside/exterior regions of the structure. In this way, the pores/openings formed in the structure can receive gas/fluid mixture containing carbon dioxide.

Optionally, the structure comprises interconnected filaments of building material printed in a plurality of stacked layers, wherein the filaments of the consecutive layers are connected to one another to obtain a porous arrangement with intra-structure pores formed between filaments.

The structure of the disclosure provides significant advantages for capturing carbon dioxide. An adequate viscosity can be obtained for forming a stable building material and in order to ensure shape and dimensional stability, and in order to permit conversion of building material in a 3D monolith shape with interconnected intra-structure channels/pores. This viscosity can be steered by adapting the solvent/water content during manufacturing.

Advantageously, after having been shaped into a three-dimensional monolith, the building material may only require a drying treatment step to provide the three-dimensional monolithic carbon dioxide capture structure. The temperatures used to achieve CO₂ desorption from the CO₂ capture structure have been found sufficient to achieve drying and binder curing, hence no calcination is required and manufacturing can be accomplished in the temperature range in which the CO₂ capture structure will be used. Absence of calcination is energetic advantage, provides dimensional stability, minimizes risk to shrinking and crack formation.

Optionally, the structure is manufactured by means of at least one printing nozzle configured to deposit a paste of building material in an interconnected arrangement in order to form the 3D monolith porous structure. Optionally, the nozzle has a diameter at least 5 times larger than the D90 particle size (i.e. 90% of the particles has a diameter lower than this value) of the solid particles in the paste of building material, preferably at least 7 times larger, for example 10 times larger. Optionally, the paste of building material has particle sizes smaller than 45 micrometer.

The building material (e.g. paste, suspension, etc.) can be extruded through a nozzle for three-dimensional filament deposition. The deposited filaments can form a layered network. The layers may for instance be successively printed on top of each other, resulting in a structure formed by a stack of successive layers. The filaments are spaced apart with respect to each other in order to define channels therebetween. A porous structure with pores can thus be obtained in this way.

The layerwise deposition of the filaments may include extruding a material through a deposition nozzle to form the filaments while moving the deposition nozzle relative to the print bed. The nozzle can be moved with respect to the print bed, and/or vice versa. Hence, kinematic inversions are also envisaged.

Optionally, the structure has at least two stacked layers, more preferably at least three stacked layers, even more preferably at least four stacked layers.

The structural geometry of the porous structure can be determined by the position and orientation of individual filaments. Filaments may for example be oriented at 0° and 90° on alternate layers. This arrangement is also known as “0/90 orientation”. However, many other arrangements are possible, for instance 0/60/120 orientation in which filament orientations are changed by 60° on each subsequent layer. For porous structures with a 0/90 filament orientation, porosity can be considered as a series of long intersecting columnar pores. Alternatively, pores may more closely resemble the geometry of a spiral staircase for a 0/60/120 filament orientation. Many other filament orientations are possible resulting in different pores of the porous structure.

Other aspects of filament positioning can also be varied. For instance, the filaments can be aligned or staggered. In an aligned arrangement of filaments, the filaments are aligned directly above similarly oriented filaments on lower layers. In a staggered arrangement of filaments, the filaments are staggered in an alternating manner by off-setting their horizontal position. These filaments form offset layers and/or diagonal pores. Furthermore, it is also possible that several identical layers are printed before the filament orientation is changed.

Various different deposition techniques may be employed as the manufacturing process for the porous structure. For example, a 3D model can be imported into an additive manufacturing computer program product. This computer program product may perform a computer implemented method configured to generate a print path, wherein an overall model is converted into layers and for each single layer a print path is determined along which the fibers are deposited.

Design parameters such as filament gap, filament diameter and lay down angle play significant roles in controlling porous and mechanical characteristics. For instance, increasing the lay down angle can also increase the porosity which can influences the mechanical properties of the porous structure. By locally providing a customized or adapted printing arrangement the preselected one or more frangible regions can be included in the porous structure to be manufactured.

Optionally, a material extrusion additive manufacturing process is employed in which a material is deposited continuously in a chosen arrangement.

Optionally, the carbon dioxide capture structure is made of a sorbent mixture which contains a foam building material. For example, a sorbent mixture containing a foam building material may be extruded in order to form a 3D monolith structure. Various foaming agents can be used in the building material.

The solvent may be a water-based liquid. However, it is also possible to use an alcohol, or a water-alcohol mixture. In some preferred embodiments, a water-based solvent may be preferred. The solvent may be removed upon drying (cf. treating), which can be performed at relatively low temperatures.

The low temperature heat treatment can ensure at least one of:
A maintenance of the dimensional stability of the three-dimensional structure (absence of shrinkage). Upon solvent/water removal, the silicate adheres to the surface of the sorbent material particles and the shape is fixed. As a result, mechanical strength is developed upon drying already, i.e. at low temperature.
A shape maintenance. This is very important when designing specific structures to minimize pressure drop.
A minimal risk to the formation of cracks or breaking of the structure.
A high mechanical strength.
A good thermal and chemical stability.

Optionally, the treating includes drying without performing any subsequent calcination steps.

It will be appreciated that the mixing may be carried out in one or more steps. Furthermore, if mixing is carried out in multiple steps, the order of the mixing steps can be changed. For example, the solvent and the second material may be mixed, and subsequently the first material may be added. However, various other mixing orders can be employed, for instance involving first mixing the first and second materials and subsequently adding the solvent.

The potassium silicate binder may be employed in a liquid state (e.g. aqueous solution or dispersion). However, it is also envisaged that the potassium silicate binder may be employed in a solid state. For example, a powder of potassium silicate binder may be used. In some examples, the powder can be dissolved in a solvent such as water. Such an approach may provide more flexibility in tuning the solvent content, and thus the resulting viscosity. The viscosity may play a significant role in the method of making the carbon dioxide capture product, for example including 3D printing the sorbent mixture, extrusion of the sorbent mixture.

When the formed three-dimensional structure is dried, moisture (cf. water) evaporates, and the silicate can solidify on the surface of the material of the structure. By mixing the potassium silicate with a solvent, a solution or dispersion of potassium silicate particles can be obtained, which can result in a more homogeneous distribution of potassium silicate over the first material. However, it is also envisaged to use potassium silicate binder material in solid form (e.g. powder). Then, afterwards, a solvent (e.g. water) can be added in order to obtain a solution/dispersion when mixing the binder with the first material.

Optionally, treating includes drying the formed porous structure at a temperature ranging from 40° C. to 150° C., preferably 60° C. to 150° C., more preferably 60° C. to 120° C., most preferably from 75° C. to 110° C. The temperature (T) can be contingent upon the pressure and humidity levels present during the drying process, as well as the application of vacuum, reduced pressure, atmospheric pressure, or elevated pressure conditions. The optimal temperature (T) is reliant upon the specific material being utilized. The selection of temperature is crucial to ensure that it does not have any detrimental impact on the carbon-based sorbent material, thereby preserving its structural and functional integrity.

The treating may include a drying step at relatively low temperatures, preferably less than 150° C., more preferably less than 140° C., even more preferably less than 130° C. In some examples, the drying is performed with temperatures in a range of 70° C. to 120° C. such as to get a binder effect. No subsequent heat treatment at higher temperatures may be required (e.g. calcination at higher temperatures). In some examples, the drying is performed with a temperature in a range of 80° C. to 110° C., preferably 90° C. to 100° C. Using the building material according to the present disclosure can effectively prevent heat treatment with temperatures higher than 150° C., and provide treatment in the temperature range in which the CO₂ capture structure will be used.

Optionally, the three-dimensional monolithic carbon dioxide capture structure is built layer by layer employing a three-dimensional printing process.

Mixing the first material, second material and solvent may provide for a viscous composition. The viscous composition may be arranged in a monolith 3D shape. In some examples, the amount of solvent is chosen such as to obtain a viscosity adequate for 3D printing and/or extrusion for producing the monolith 3D structure. The treatment may be carried out for drying the formed monolith structure, so that moisture (e.g. water) can be removed. Advantageously, the drying process can be effectively carried out at low temperatures, such as for instance around 60° C. When sufficient water has evaporated, a solid monolith carbon dioxide capture structure is obtained.

According to an aspect, the present disclosure relates to a method for removing carbon dioxide from a gas or fluid mixture, the method comprising: bringing the gas or fluid mixture in contact with a carbon dioxide capture structure obtained by the above-described method; and capturing at least a portion of the carbon dioxide in the gas or fluid mixture in the carbon dioxide capture structure; and wherein the carbon dioxide capture structure has a monolith three-dimensional shape, the structure being porous with interconnected pores which are accessible from an exterior side of the structure, wherein the structure is made of a building material comprising a first material and a second material, wherein the first material is a sorbent material comprising a carbon-based sorbent material, and wherein the second material is a binder material including potassium silicate.

The use of potassium silicate as a binder for forming the building material can result in beneficial adsorption capacities obtained by the carbon dioxide capture structure. Moreover, an effective desorption can be obtained at relatively low temperatures. For example, if sodium silicate or lithium silicate is used as binder, regeneration must be carried out at much higher temperatures. Hence, employing a potassium silicate binder has significant advantages for adsorption and desorption processes, especially compared to other types of binders such as sodium silicate and lithium silicate or other inert binders such as clay materials. Much higher temperatures may be needed for performing effective adsorption and desorption steps for such other binders.

In some preferred embodiments, activated carbon is used as the carbon-based sorbent material. Because of hydrophobic nature, penetration of binder into the pore system of the sorbent material is minimized and high accessible surface remains. A carbon dioxide containing gas may contain a relatively large amount of moisture or water. Because of hydrophobic nature, CO₂ sorption is promoted over H₂O sorption. With zeolites, more hydrophilic surface permits penetration and adsorption of binder into the pore system, which may lead to a reduction of the active surface available for CO₂ sorption in some cases. Therefore, if a mixture of a carbon-based solvent and a zeolite is envisaged, the amount of zeolite incorporated in the sorbent material is advantageously kept as small as possible. Hence, by employing carbon-based material as the first material, it can be prevented that CO₂ sorption is hindered by H₂O sorption, and thus no additional drying of the fluid/gas in advance (i.e. pre-processing step) may be required. Furthermore, there is only a minor decrease in density when combining the binder with the activated carbon powder, leading to a volumetric capacity of 1.14 mmol/cm³ when compared to pure activated carbon powder with a capacity of 0.52 mmol/cm³.

Optionally, the building material has 20-80 wt. % binder material, preferably 30-70 wt. %, more preferably 40-60 wt. % for enabling adequate building of the monolith 3D structure, for example using 3D printing or extrusion. Such quantities may better ensure that a dimensional and/or a mechanic stability is maintained throughout adsorption/desorption cycles, even at temperatures needed to ensure full CO₂ desorption.

Optionally, one or more successive cycles are performed, each cycle involving an adsorption step and a subsequent desorption step, wherein carbon dioxide in the gas or fluid mixture is captured in the carbon dioxide capture structure in the adsorption step, and wherein the carbon dioxide captured in the carbon dioxide capture structure is released in the desorption step, wherein the desorption step is carried out at room temperature, preferably at an elevated temperature, wherein the elevated temperature is greater than 60° C., preferably greater than 80° C., even more preferably greater than 100° C., and wherein the adsorption step is carried out at an absolute pressure in a range of 0.01 to 35 bar, preferably 0.1 to 35 bar, more preferably 1 to 35 bar, preferably 1 to 10 bar, and wherein the desorption step is carried out at an absolute pressure in a range of 100 mbar to 1 bar, preferably 30 mbar to 1 bar, more preferably 20 mbar to 1 bar.

Advantageously, a significant increase in adsorption capacity can be obtained by employing a building material including the first material and the potassium silicate binder material.

In some examples, the adsorption step is carried without performing a heating step (e.g. at a room temperature), and the desorption step is carried out by performing an optional heating step for bringing the structure to an elevated temperature. The desorption step can be carried out at room temperature or an elevated temperature higher than 60° C., for example higher than 80° C., or for example higher than 100° C. Usually the desorption temperature will be kept below 200° C., preferably below 150° C. to minimize the risk to oxidation of the carbon-based sorbent material.

In some examples, the desorption step is carried out at a desorption temperature which is adequate for making the carbon dioxide structure ready for a subsequent adsorption step. It has been experimentally observed that the desorption can advantageously be carried out even at room temperature. In some cases, the desorption step is carried out at relatively low elevated temperatures for improving the desorption, and thus enabling more effective adsorption at the subsequent adsorption step.

Although desorption may even be carried out at room temperature in some examples, in some examples, at lower temperatures such as room temperature, a loss of capacity may be obtained as a result. Desorbing at higher temperatures may mitigate this effect, as potassium carbonate decomposition can proceed better over time, which can better ensure a decent adsorption capacity. In some examples, desorption at elevated temperatures above 150° C. may result in no or only negligible detrimental effects on the adsorption capacity in the subsequent adsorption step.

It will be appreciated that instead of performing temperature swings, it is also envisaged to, additionally or alternatively, perform pressure swings (e.g. varying pressure during the desorption step).

The method can be used for capturing carbon dioxide in industrial gases (e.g. having low concentrations of carbon dioxide, such as for instance below 15 percent). However, the structures can also be used to selectively extract carbon dioxide from a biogas, for example to produce methane. Such biogas may include higher concentrations of carbon dioxide. The adsorption capacity of structure may increase at higher carbon dioxide concentrations in the to be treated fluid/gas. In some examples, the first material is carbon based (e.g. activated carbon) and the gas or fluid mixture comprises at least 5%, preferably at least 10% carbon dioxide.

The structure according to the disclosure can also be used for capturing carbon dioxide in low concentration gasses or fluids. In some examples, the gas or fluid mixture comprises 10% or less carbon dioxide, for example 5% or less carbon dioxide.

According to an aspect, the present disclosure provides for a system for removing carbon dioxide from a gas or fluid mixture, comprising: a compartment with one or more carbon dioxide capture structures according to the disclosure placed therein; and a guiding unit configured to at least partially flow the gas or fluid mixture through intra-structure pores of the one or more carbon dioxide capture structures placed within the compartment.

Optionally, the sorbent structure is manufactured by means of 3D printing, filament deposition manufacturing, extrusion or robocasting. In some examples, for carbon dioxide adsorption relatively high volumes of fluid are to be guided along the carbon capture structure. By employing monolithic 3D shaped carbon dioxide capture structures, for example obtained by performing 3D printing, extrusion, robocasting, or the like, a relatively low pressure drop and adequate kinetics can be obtained. The mixture of the first and second material is suitable for manufacturing 3D monolithic structures with interconnected pores (e.g. lattice structure).

According to an aspect, the present disclosure provides for a use of a carbon dioxide capture structure according to the disclosure for removing at least carbon dioxide from a gas or fluid mixture.

According to an aspect, the present disclosure provides for a method for producing a porous three-dimensional CO₂ monolithic sorbent structure, the method comprising depositing interconnected filaments of a building material in a predetermined arrangement in a plurality of consecutively stacked layers, and subjecting the thus obtained structure to a heat treatment, wherein the building material comprises particles of a porous sorbent material, a binder and a solvent, wherein the binder is potassium silicate and wherein the heat treatment is carried out at a maximum temperature of 150° C.

The building material may for example be used in a 3D printing process (e.g. filament deposition, robocasting, extrusion-based additive manufacturing, etc.). However, other manufacturing processes may also be employed. For example, the structure may be manufactured by means of extrusion.

For example, pure activated carbon may have a limited capacity. With the potassium silicate binder, the carbon dioxide adsorption achievable by means of the carbon dioxide structure can be significantly increased.

It will be appreciated that exterior side of the structure may be a periphery of the structure. The periphery may extend along an outer edge of the structure.

The monolith carbon dioxide capture structures according to the disclosure can be used in other devices or systems. For example, a bed or enclosure may be employed having a plurality of monolith structures (i.e. not beads) arranged therein, in a structured or unstructured manner. The pressure drop over a packed bed of beads can be relatively high. Advantageously, the pressure drop can be reduced by employed a packed bed of 3D monolith structures according to the disclosure.

According to an aspect, the present disclosure relates to a packed bed of carbon dioxide capture structures according to the disclosure, or which are obtained by performing the method according to the disclosure. The structures may have the same or different monolith 3D shape. Furthermore, the structures may have the same or different dimensions, geometries, characteristics, etc.

Optionally, multiple carbon dioxide capture structures are arranged in a structured arranged within the bed. For example, the structures can be arranged next to each other and/or on top of each other in a carbon dioxide capture device comprising such a bed. The structures can be stacked in different ways. Various structured configurations of monolith structures are envisaged.

It will be appreciated that, in accordance with the disclosure, various other additives, including but not limited to conventional additives, can be incorporated into the sorbent mixture for example in order to enhance its performance and properties. Such conventional additives may encompass a wide range of substances, for example a plasticizing agent, a viscosity modifier etc. The incorporation of these additives may occur at various stages of the sorbent structure preparation process, such as for instance prior to mixing the primary components of the sorbent and/or during the mixing process itself. In some examples, the addition of these other (conventional) additives at one or more specified intervals allows for improved homogeneity, increased effectiveness, and optimized functionality of the resulting produced sorbent material structure, tailored to specific applications and operational conditions.

It will be appreciated that according to the disclosure, relative quantities of the components may be given based on their dry weight, in relation to the overall dry weight composition of the building material and/or that of the sorbent structure.

It will be appreciated that terms like “binder”, “glue” and “adhesive” may be used interchangeably referring to a material including potassium silicate (cf. second material).

“Optional” or “optionally” means that the subsequently described event or circumstance may or may not occur, and that the description includes instances where said event or circumstance occurs and instances where it does not.

It will be appreciated that, unless otherwise specified, the use of the ordinal adjectives “first”, “second”, “third”, etc., to describe elements, merely indicate that different instances of elements are being referred to, and are not intended to imply that the elements so described must be in a given sequence, either temporally, spatially, in ranking, weight percentage, or in any other manner.

It will be appreciated that the order in which various described method steps are performed may be changed, and in some alternative embodiments one or more method steps may be skipped altogether.

It will be appreciated that any of the aspects, features and options described in view of the carbon dioxide capture structure apply equally to the methods and systems of the disclosure. It will also be clear that any one or more of the above aspects, features and options can be combined.

### BRIEF DESCRIPTION OF THE DRAWINGS

The present disclosure will further be elucidated on the basis of exemplary embodiments which are represented in a drawing. The exemplary embodiments are given by way of non-limitative illustration. It is noted that the figures are only schematic representations of embodiments of the present disclosure that are given by way of non-limiting example.

In the drawing:

FIG. 1 shows a schematic diagram of an embodiment of a carbon dioxide capture structure;

FIG. 2 shows a schematic diagram of an embodiment of a method;

FIG. 3 shows a schematic diagram of an embodiment of a method;

FIG. 4 shows an exemplary spectrum;

FIG. 5 shows an exemplary chart;

FIG. 6 shows an image of an exemplary embodiment of structures;

FIG. 7 shows a microscopy image of an exemplary structure;

FIG. 8 shows an exemplary graph;

FIG. 9 shows an exemplary graph;

FIG. 10 shows an exemplary chart;

FIG. 11 shows an exemplary chart;

FIG. 12 shows exemplary graphs; and

FIG. 13 shows an exemplary chart.

### DETAILED DESCRIPTION

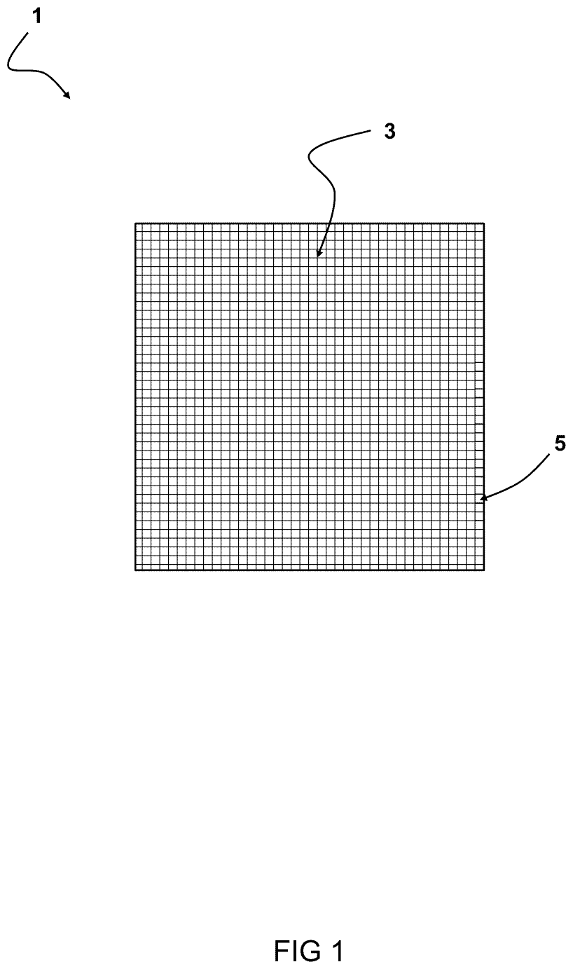

FIG. 1 shows a schematic diagram of a top view of an embodiment of a carbon dioxide capture structure 1. The structure 1 has a monolith three-dimensional shape. The structure 1 is porous with interconnected pores 3 which are accessible from an exterior side 5 of the structure 1. The structure 1 is made of a building material which includes a mixture of a first material and a second material, wherein the first material is a carbon-based CO₂ sorbent material, and wherein the second material is a binder material including potassium silicate.

Advantageously, using a carbon based first material (e.g. activated carbon) and potassium silicate binder material can result in a strong synergistic effect. For example, activated carbon on its own may have a relatively low adsorption capacity, and the potassium silicate binder on its own may have a negligible adsorption capacity (cf. the potassium silicate binder itself may not adsorb carbon dioxide). However, building the carbon dioxide capture structure based on a mixture of a carbon-based material and a potassium silicate binder may significantly increase the adsorption capacity, whilst also providing advantageous processing capabilities related to (post-) treating of the formed structure (cf. low temperature drying) and/or adsorption/desorption processing conditions (e.g. low temperature).

The monolith structure can be used for removing carbon dioxide from a gas mixture, even if the gas mixture contains a relatively low concentration of carbon dioxide, for example less than 10 percent. In some examples, the gas mixture may contain other components, such as water. The functional groups in a carbon based first material (e.g. activated carbon) and its specific surface can enable effective carbon dioxide adsorption.

Advantageously, by employing the potassium silicate binder, the formed 3D carbon dioxide capture structure does not require calcination at high temperatures (e.g. above 500° C., for example about 700° C.).

In some examples, the first material is a carbon-based material. In some examples, the first (sorbent) material may contain a carbon-based material, and minor amounts of a further CO₂ sorbent material, for example a zeolite, an aluminum oxide, a clay material (e.g. clay mineral or synthetic clay), or a material with amine functional groups, such as for instance an amine functionalized polymer/resin or organic polymer/resin. For example, materials with amine groups may lose essential functionality as a result of elevated temperatures above a certain threshold. Advantageously, the present disclosure according to the disclosure effectively enables avoiding such damage temperatures. The amount of further CO₂ sorbent material will usually not be higher than 25 wt. % of the weight of the first (sorbent) material, preferably not higher than 20 wt. %.

Different types of porous structures can be manufactured. Such structure may represent a mesh, a lattice structure, a filament network, a scaffold, a filament framework, or the like. Many types of arrangements and structures are possible. The specific arrangement, configuration and/or dimensions of the structure may be selected and designed in different ways.

The structure may be shaped using various shaping or manufacturing techniques, such as for example 3D printing, robocasting, filament deposition, extrusion, etc.

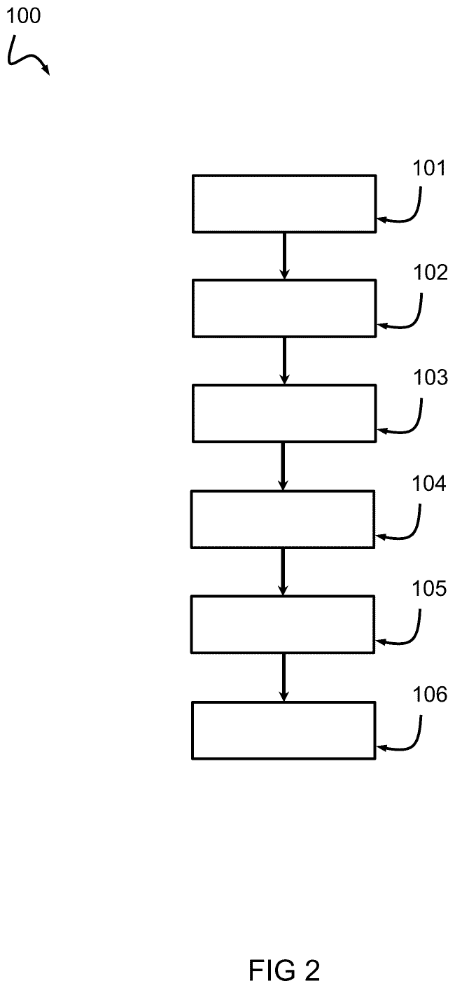

FIG. 2 shows a schematic diagram of an embodiment of a method 100 of making a carbon dioxide capture product. In a first step 101, a first material is provided, the first material being a sorbent material (e.g. functionalizable for carbon dioxide adsorption). In a second step 102, a second material is provided, the second material being a binder material including Potassium silicate. In a third step 103 a solvent such as water is provided. In a fourth step 104, the first material, second material and the solvent are mixed in order to produce a sorbent mixture. In a fifth step 105, a monolith three-dimensional porous structure is built using the sorbent mixture as building material. In a sixth step 106, the monolith three-dimensional porous structure is treated so as to obtain the carbon dioxide capture product, wherein the treating includes drying with a maximum temperature of 150° C.

Advantageously, the method does not require any high temperature thermal treatment. The heat treatment can be carried out without exceeding a maximum temperature of 150° C. A low temperature (heat) treatment can result in a more efficient and cost-effective process. Various heat treatment steps can be carried out, whilst the treatment temperature is kept below 150° C.

In some examples, a drying temperature lower than 130° C. may be employed. For example, the drying temperature may be in a range of 80-110° C. Such relatively low temperatures may be sufficient for obtaining the binding effect of potassium silicate and make the surface of the building material available for carbon dioxide adsorption. In some examples, a freeze-drying treatment step is carried out.

The solvent may ensure that the potassium silicate binder remains dissolved or dispersed. A fine distribution of potassium silicate on the first material (e.g. activated carbon) may ensure beneficial carbon dioxide sorption by the carbon dioxide capture structure. Using a solution or dispersion of the binder material may thus result in a fine distribution of potassium silicate on the first material. Due to an improved distribution of the potassium silicate binder, adsorption and kinetics of the manufactured carbon dioxide capture structure may be significantly improved. However, this effect may also be obtained by adding a solvent during mixing of the first and second materials.

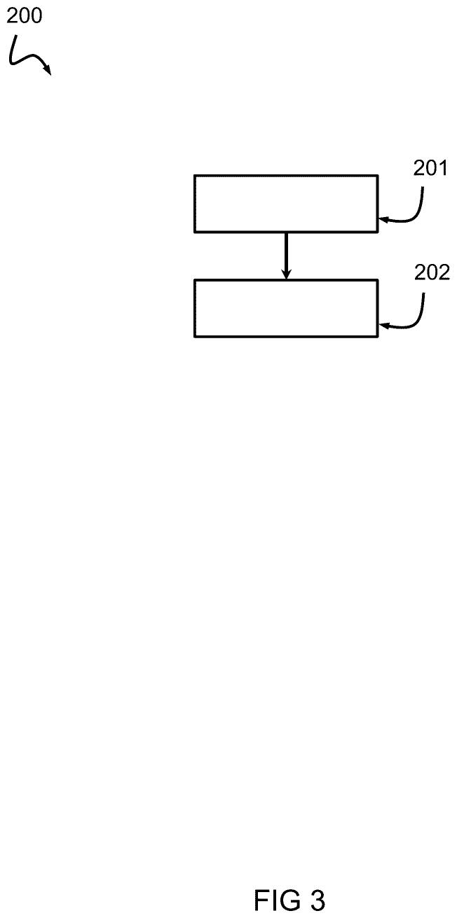

FIG. 3 shows a schematic diagram of an embodiment of a method 200 for removing carbon dioxide from a gas or fluid mixture. In a first step 201, the gas or fluid mixture is brought in contact with a carbon dioxide capture structure, wherein the carbon dioxide capture structure has a monolith three-dimensional shape, the structure being porous with interconnected pores which are accessible from an exterior side of the structure, wherein the structure is made of a building material comprising a first material and a second material, wherein the first material is a sorbent material, and wherein the second material is a binder material including potassium silicate. In a second step 202, at least a portion of the carbon dioxide in the gas or fluid mixture in the carbon dioxide capture structure is captured.

### EXAMPLES

Below experimental results are described for potassium silicate as low-temperature binder in 3D-printed porous structures for CO₂ separation. It will be appreciated that other manufacturing processes, such as extrusion, may also be employed.

A commercial potassium silicate solution is combined with activated carbon and subsequently shaped by 3D micro-extrusion. However, other manufacturing techniques may be employed for building the carbon capture structure according to the disclosure. After shaping, the aqueous silicate solution can transition to a carbonate described by the following reactions:

Transition from Silicate to Carbonate

K₂SiO₃+2CO₂+H₂O↔2KHCO₃+SiO₂

### Desorption Reaction

2KHCO₃+0.5H₂O↔K₂CO₃·1.5H₂O+CO₂

2KHCO₃↔K₂CO₃+H₂O+CO₂

### Adsorption Reaction

K₂CO₃·1.5H₂O+CO₂↔2KHCO₃+0.5H₂O

K₂CO₃+CO₂+H₂O↔2KHCO₃

This results in a structured hybrid adsorbent, combining chemisorption and physisorption, avoiding the need of a high-temperature thermal treatment and providing high mechanical strength, good chemical and thermal stability while retaining or improving the total CO₂ capacity. The use of potassium silicate as binder for building a 3D shaped monolith carbon dioxide capture structure provides significant advantages. The building material is well suited for 3D printing, extrusion, or the like. Moreover, potassium typically shows higher sorption capacity as well as faster kinetics at lower temperatures in comparison with sodium silicates, enabling a new type of regenerable chemical absorbents.

### Paste Preparation and Monolith Printing

The 3D-printing paste was prepared by a mixture of Activated Carbon powder, a potassium silicate binder and distilled water. Using an ARE Thinky mixer, the different components were mixed in several ratios to obtain a printable paste, while providing high mechanical strength and a maximized total CO₂ capacity. Subsequently, the paste was loaded into a syringe and extruded by using a mechanically driven piston, mounted on a CNC machine. A constant volume flow was ensured by the piston, extruding fibers through a nozzle of 600 μm. Squared monolithic-type structures were constructed layer by layer until a beam of 5 cm height and 2 cm diameter was obtained. The distance between each fiber in a layer was kept at 600 μm while each successive layer was rotated with 90°. After printing, the structures were dried using a Thermo Scientific Heratherm at 94° C. for 8 hours to obtain a mechanically strong printed monolith. No additional high-temperature thermal treatment was performed.

### Adsorbent Characterization

Characterization of the adhesive was performed in terms of Fourier Transform—Infrared spectroscopy and Inductively Coupled Plasma spectroscopy. Specific surface area and micropore volume determination of the 3D-printed adsorbent were analyzed from N₂ isotherms at liquid nitrogen temperatures (77K). Sample activation was performed overnight at 120° C. under vacuum. Mercury Intrusion Porosimetry was performed. The pore sizes were calculated using a contact angle of 140° and a surface tension of 480 Dynes/cm. He-pycnometry was determined. X-Ray Diffraction measurements were carried out. Phase identification was carried out. Scanning Electron Microscopy was performed. The CO₂ capacity of the composite sorbents were evaluated.

### RESULTS AND DISCUSSION

### Characterization of Commercial Binder

Characterization of the commercial adhesive was performed in terms of Fourier-Transform infrared spectroscopy (FT-IR).

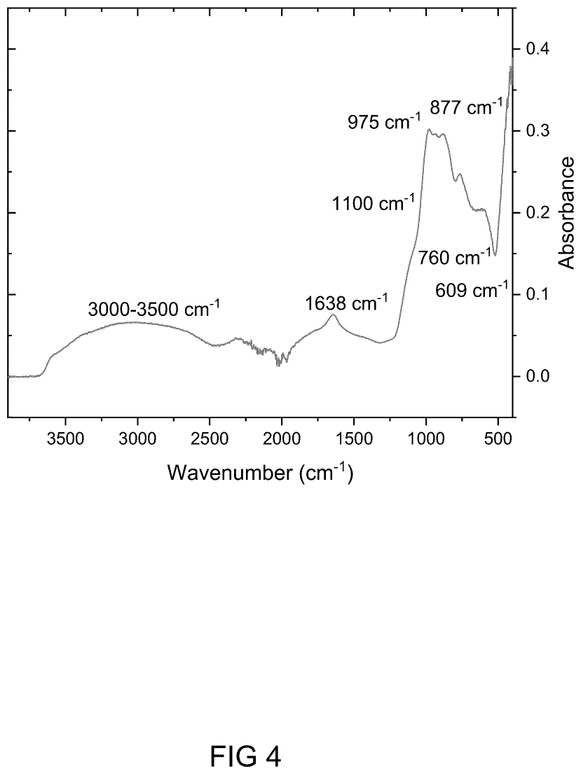

FIG. 4 shows a FT-IR spectrum of a silicate adhesive, measured in crushed powder-form. The FT-IR spectrum of the pure silicate binder, which was dried at 94° C. overnight prior to crushing of the sample to perform the analysis, is shown.

The silicate binder presented several characteristic vibration bands between 500 and 1100 cm⁻¹, confirming the nature of the binder. The presence of silicate and silica functionalities is acknowledged by the vibration bands detected at 609 cm⁻¹, 760 cm⁻¹, 877 cm⁻¹, 975 cm⁻¹ and 1100 cm⁻¹ corresponding to the Si—O, Si—O—Si, Si—O, Si—OH and Si—O—Si vibration respectively. Moreover, a broad band between 3000 cm⁻¹ and 3500 cm⁻¹ and a peak at 1638 cm⁻¹ is observed, confirming the presence of hydroxyl functionalities and/or adsorbed water molecules at the silicate surface.

Additionally, inductively coupled plasma (ICP) spectroscopy was performed to analyze the nature of the silicate adhesive in terms of counterions, which largely influences the total CO₂ capacity, the kinetic behavior as well as regeneration temperature. ICP confirmed the presence of a mixture of potassium and sodium counterions, with potassium as the dominant species in a concentration of 74.7 g/L in comparison with sodium at 0.43 g/L. The concentration of silicium in the binder solution was equal to 129 g/L resulting in a total Si/K+Na weight ratio of 1.72.

### Additive Manufacturing of Monolithic Sorbents

In a next step, the silicate binder was combined with an activated carbon powder in different ratios to develop a suitable paste composition for 3D-printing. The activated carbon/adhesive ratio was varied between 70/30 and 40/60 to evaluate and balance the printability, mechanical strength of the sorbent after printing and the effect on the CO₂ sorption capacity.

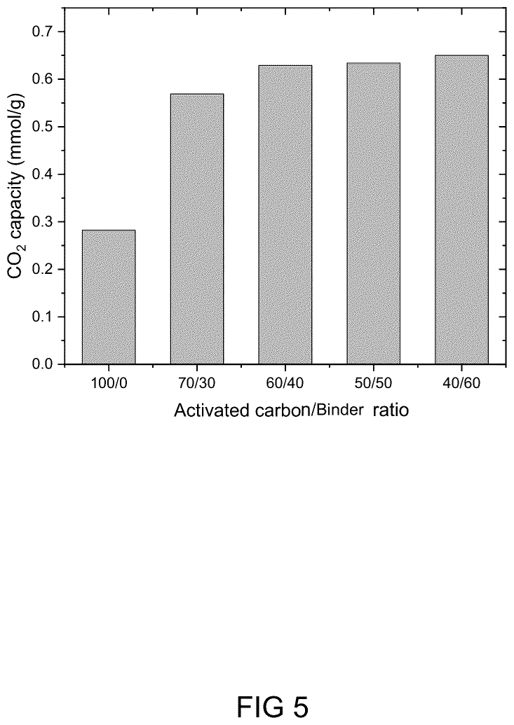

FIG. 5 illustrates an effect of activated carbon/binder ratio on the total CO₂ capacity at 9.1% CO₂, analyzed by TGA. As observed in FIG. 5, a large improvement in CO₂ capacity is observed when adding more binder (i.e. adhesive, glue) to the activated carbon material. At a 70/30 ratio between activated carbon and binder, the CO₂-capacity doubles from 0.28 mmol/g for the activated carbon powder to 0.57 mmol/g for the composite. The mechanical strength at this ratio may be less suitable to self-support a printed structure, and more binder may be needed to achieve the necessary mechanical strength. However, each increase in the amount of aqueous binder solution may significantly decreases the viscosity of the mixture, which can negatively affect the printability. Ratios higher than 50/50 may therefore in some examples be unsuitable for printing. To achieve a balance between final mechanical strength and printability, an optimum can be selected by combining the activated carbon with the binder in a 50/50 ratio. At this ratio, an excellent CO₂ capture capacity of 0.62 mmol/g has been observed.

To take into account the effect of the binder on the density and volumetric capacity of the composite material, the density of the cured and dried binder, the pure activated carbon powder and the selected 50/50 ratio composite (cured and dried) was determined by He-pycnometry. The respective results are 2.019 g/cm³ (adhesive), 1.869 g/cm³ (AC powder) and 1.817 g/cm³ (composite). These results indicate a very minor decrease in density when combining the binder with the activated carbon powder, resulting in the observation of a similar trend in terms of the volumetric capacity of the composite material compared to the CO₂-capacity based on weight (activated carbon powder 0.52 mmol/cm³ versus 1.14 mmol/cm³).

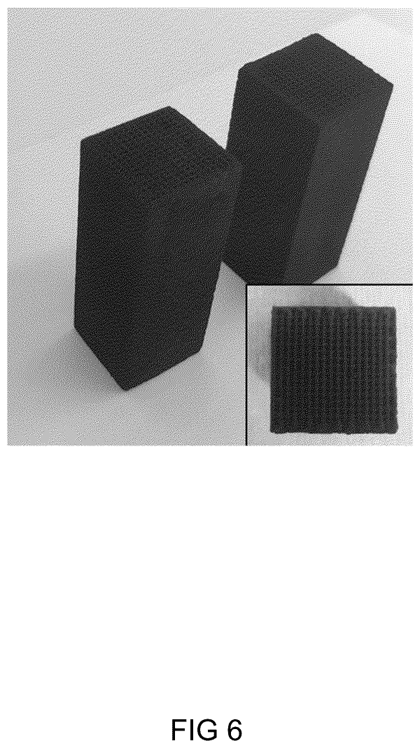

FIG. 6 shows images of the 3D-printed activated carbon/silicate binder composites. After drying, the final monoliths display a height of 4.8 cm and diameter of 1.8 cm. The optimized paste formulation was loaded into a syringe and 3D-printed into monolithic-type structures using a 600 μm nozzle. The printed monoliths were subsequently transferred to the drying furnace at 94° C. for at least 8 hours to remove excess moisture and to achieve mechanically strong sorbent monoliths. No significant shrinkage (<10%) or deformation was observed during the low-temperature treatment, preserving the overall shape and structure of the composite. The final monoliths are depicted in FIG. 6.

### Adsorbent Characterization

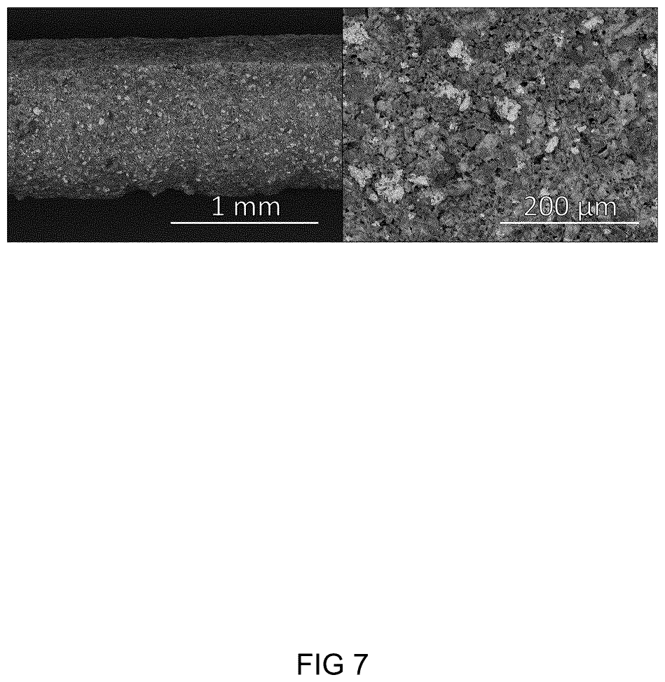

FIG. 7 shows scanning electron microscopy (SEM) images of a single extruded fiber consisting of the activated carbon and silicate binder. SEM images of a single composite fiber were taken to evaluate the distribution of the silicate binder throughout the activated carbon. A highly porous fiber was observed, while the silicate binder was homogenously distributed throughout the structure, as shown in FIG. 7. An excellent wetting of the activated carbon powder by the binder is observed in the SEM image, further confirmed by the minor decrease in density of the composite material versus the original activated carbon powder and cured binder.

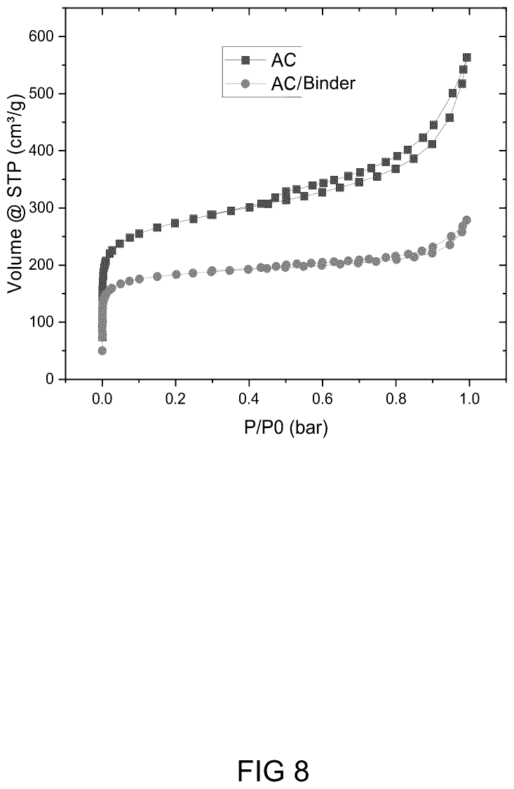

FIG. 8 shows N₂ isotherm of the activated carbon powder compared to the activated carbon/binder composite. A complete porosity characterization was performed using a combination of several techniques, including N₂, Ar and CO₂ sorption as well as mercury intrusion porosimetry. N₂ isotherms of the crushed monolith structure in comparison with the activated carbon powder are shown in FIG. 8. A significant change in isotherm shape is observed, indicating a clear difference in pore shape, size and total pore volume. The activated carbon powder shows a typical type IV isotherm due to its hysteresis loop associated with capillary condensation, indicative of the presence of mesopores. This can be associated with the plate-like carbon particles, forming slit-like pores. Moreover, a steep increase is observed at the lower pressure range, indicating a significant amount of micropores as well. Addition of the silicate binder to the monolith structure clearly reduces the total meso- and micro-porosity, indicated by the loss in hysteresis as well as the reduced uptake in the lower pressure range. A reduction of the BET-value from 1010 m²/g to 700 m²/g is observed for the activated carbon powder and the composite, respectively. Using the t-plot method, a decrease of ˜20% in micropore volume is shown as well, due to the presence of the silicate binder. The cured binder itself displayed a very low BET surface area (1.2 m²/g), therefore a full isotherm of this material is not included.

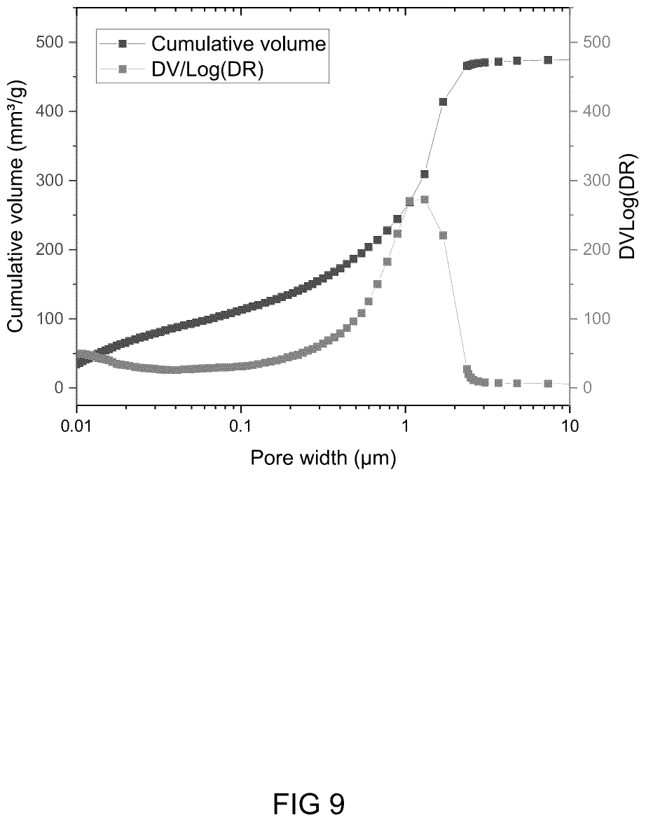

FIG. 9 shows mercury porosimetry measurement on the activated carbon/binder composite. FIG. 9 includes the pore size distribution measured by mercury intrusion porosimetry on the structured monolithic composite sorbent. Around 0.43 g of 3D-printed material was used to evaluate the macroporosity of the structure. The measurement indicates a high amount of intrastructural porosity (45.7%) inside the fibers. A total cumulative volume of 480 mm³/g is shown, while the average pore radius and density was equal to 0.92 μm and 1.76 g/cm³ respectively.

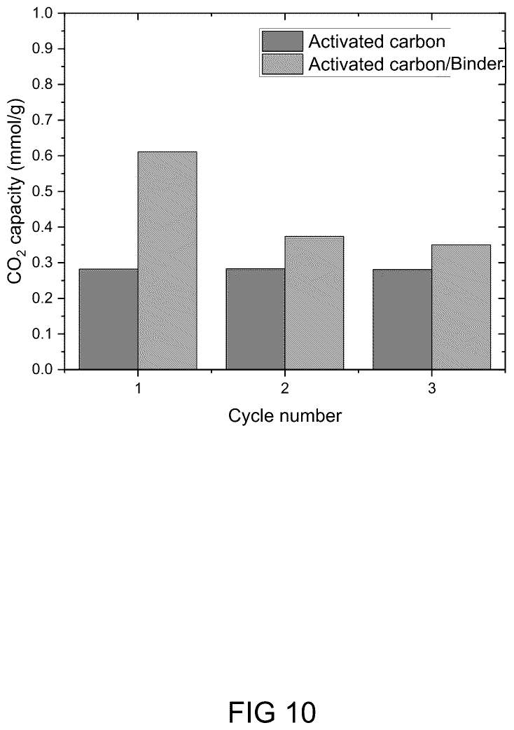

FIG. 10 shows a comparison of the cyclic CO₂ sorption capacity at 9.1 Vol % CO₂, analyzed by TGA. The sample is degassed at 120° C. prior to the first cycle and subsequently regenerated at room temperature in the following cycles.

The cyclic CO₂ sorption capacity of the composite monoliths was evaluated and compared to the activated carbon powder. In a first step, the sample was degassed at 120° C. in a N₂ flow for 3 hours. After regeneration and cooling down to room temperature, 9.1 vol % CO₂ was added to the sample chamber to evaluate the weight increase over time (cycle 1). Following the adsorption step, desorption of the CO₂ gas is induced by flowing pure N₂ through the sample chamber at room temperature. This cycle is repeated 3 times in total to evaluate the regenerability and performance of the sorbent. The comparison of the activated carbon powder and the activated carbon/binder composite is shown in FIG. 10. As observed, the CO₂ capacity of the activated carbon powder is stable over the different cycles and is able to be fully regenerated by N₂ purging without the use of an increased temperature during the desorption step. A total CO₂ uptake capacity at 9.1 vol % CO₂ of 0.28 mmol/g is observed.

In contrary to the activated carbon powder, the composite shows a significant decrease in sorption capacity throughout the different cycles.

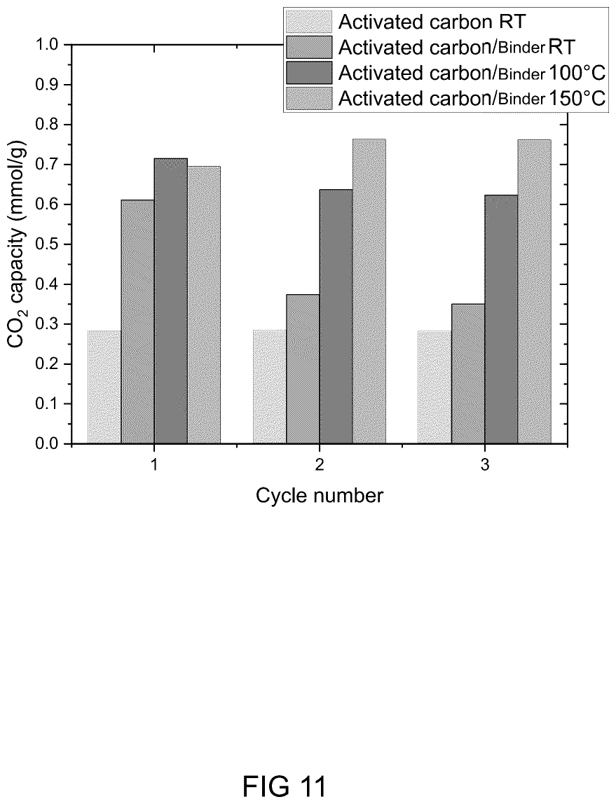

FIG. 11 shows an effect of desorption temperature on the cyclic CO₂ capacity of the activated carbon/glue composite at N₂-9.1 vol % CO₂, analyzed by TGA. Cycle 1 is equal to the CO₂ adsorption after a sample activation of 120° C. (standard). Cycle 2 and 3 are equal to the CO₂ adsorption after the degassing temperature depicted in the legend. The first cycle is after activation at 120° C. (to remove remaining water before adsorption, specifically used for getting accurate TGA measurements). For actual applications, this activation may be optional and thus not required.

Increasing the desorption temperature up to 150° C. can significantly increase the adsorption capacity (0.76 mmol/g vs 0.28 mmol/g). Furthermore, considering that the composites consist of 50% activated carbon, the adsorption capacity increases from 0.14 mmol/g to 0.76 mmol/g, i.e. about 5 times more CO₂ uptake. This shows the large potential of the potassium silicate as a low-temperature binder for carbon-based materials while having an active contribution to the overall CO₂ working capacity.

In some examples, in order to fully regenerate the composite sorbent, two different desorption temperatures were evaluated (100° C. and 150° C.). In a first step, a similar degassing procedure at 120° C. was applied as described in the previous paragraph. Adsorption was then carried out by using a 9.1 vol % CO₂ in N₂ stream, resulting in the total CO₂ sorption capacity displayed at cycle number 1. A sorption capacity between 0.60 mmol/g and 0.70 mmol/g is shown for all three samples after cycle 1, indicating the reproducibility of the composite material.

The first desorption step is then induced by increasing the temperature from room temperature up to 100° C. or 150° C. While a regeneration at room temperature significantly reduced the working capacity of the sorbent material by 40% (0.61 mmol/g to 0.37 mmol/g), regeneration at 100° C. only decreased the working capacity by 11% (0.7 mmol/g to 0.62 mmol/g). Furthermore, the sorption capacity of the material regenerated at 150° C. induced a significant increase of the CO₂ uptake by 10% (0.69 mmol/g to 0.76 mmol/g). In comparison with the reduction of the CO₂ uptake after desorption at room temperature, regenerating at higher temperatures clearly induces a significant increase in CO₂ uptake, indicating the recovery of the active sites. Using a thermal desorption step at temperatures of 100° C. and 150° C., the capacity at 9.1 vol % CO₂ is increased up to 0.62 mmol/g and 0.76 mmol/g respectively. In comparison with the activated carbon powder, this results in a CO₂ uptake that is almost tripled (0.28 mmol/g vs 0.76 mmol/g).

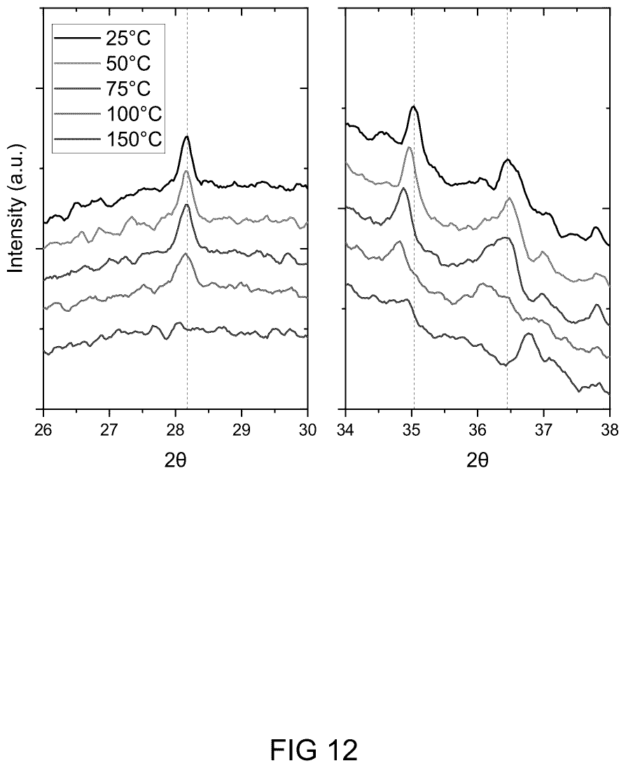

FIG. 12 shows temperature-controlled XRD spectrum to investigate the transition of KHCO₃ to K₂CO₃ at elevated temperatures.

The TGA results indicate a change in sorption mechanism when applying the adhesive to the activated carbon powder. While earlier results show the decreased specific surface area and micropore volume of the composite material, significantly higher sorption capacities were observed even after multiple cycles with room temperature regeneration. Additionally, TGA-experiments show that the active sites require higher temperatures in order to be fully regenerated. Both observations indicate that the composite material adsorbs CO₂ by a combination of physisorption in the remaining pores of the activated carbon and chemisorption. This chemisorption process is most likely the conversion of potassium bicarbonate (KHCO₃) to potassium carbonate (K₂CO₃). The incomplete regeneration at room temperature indicates that this regeneration is not sufficient to recover all chemisorption sites. Interestingly, the addition of this adhesive also increases the working capacity, even after regeneration at room temperature by N₂ flushing.

To confirm the described mechanism including the conversion of potassium bicarbonate (KHCO₃) to potassium carbonate (K₂CO₃) at higher desorption temperatures, an in situ X-ray diffraction study was performed where the temperature of the composite sample was increased stepwise up to 150° C. The result can be observed in FIG. 12, showing the diffraction pattern of the activated carbon/silicate adhesive composite. The composite was measured in crushed form at room temperature and subsequently heated up in situ to 150° C. Several XRD scans were performed during heating to evaluate the transformation of the characteristic peaks. At room temperature, three characteristic peaks can be observed at 28.18°, 35.05° and 36.55°, indicating the presence of KHCO₃. A clear reduction in peak intensities is observed with increasing temperature, confirming the conversion of KHCO₃ to K₂CO₃. Complete conversion of KHCO₃ is observed after heating at 150° C. These in situ XRD observations, coupled with the increased working capacities as displayed in the earlier TGA-looping experiments, show the large potential of the silicate adhesive as an active low-temperature binder for the creation of strong monolithic activated carbon structures, suitable for a low-temperature and energy-efficient regeneration.

In the above experimental results, structured activated carbon sorbents were developed using 3D micro-extrusion technology by using potassium silicate as low-temperature binder. A paste optimization was performed to achieve a balance between the printability, mechanical strength of the sorbent after printing and a maximized CO₂ sorption capacity. Several monolithic/multi-channel type structures were developed and characterized in terms of total pore volume, pore size distribution and the resulting CO₂ uptake. As observed using thermogravimetric analysis, the use of the silicate binder doubled the working capacity of the 3D-printed activated carbon sorbent. This working capacity dropped slightly after regeneration at room temperature using N₂-purging, but still exceeded the CO₂ uptake of the original activated carbon powder by 25%. By increasing the regeneration temperature up to 150° C., an improved working capacity of the composite material up to 0.76 mmol/g was observed after several cycles, almost tripling the working capacity of the original activated carbon powder (0.28 mmol/g). An in situ XRD study confirmed the proposed mechanism, including a combination of physisorption in the remaining activated carbon micropores and chemisorption resulting in the formation of potassium bicarbonates. These results show the large potential of the silicate adhesive as an active low-temperature binder for creating strong monolithic activated carbon structures, suitable for low-temperature and energy-efficient regeneration.

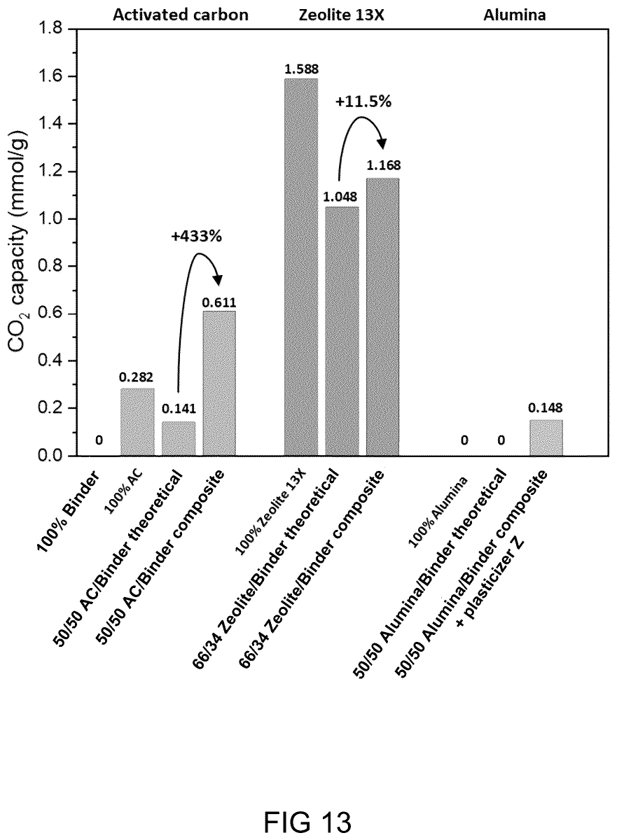

FIG. 13 shows a comparison of the CO₂ sorption capacity at N₂-9.1 vol % CO₂ of different adsorbent/potassium glue composites, analyzed by TGA. The sample is degassed at 120° C. prior to the CO₂ uptake measurement. The theoretical capacity is based on the calculation of the individual components CO₂ uptake. The glue does not show any CO₂ adsorption.

The building material of the 3D monolith structure may be a mixture/combination of potassium silicate solution with a first material. In this example, the first material is exemplary activated carbon. Other first materials may also be used. Furthermore, in this example, the structure is shaped by performing 3D printing or extrusion. After shaping, the aqueous silicate solution can transition to a carbonate described by the reactions described above.

In this example, potassium silicate solution is combined with activated carbon in a 50/50 solid ratio. Other ratios are possible.

The use of solid potassium silicate might expand the potential adsorbent/binder ratio significantly. The developed paste is structured by 3D-printing, resulting in a monolithic composite which shows sufficient mechanical strength (˜1 MPa). However, other manufacturing techniques, such as extrusion, may also be employed. No high-temperature thermal treatment is needed (usually employed by zeolites), since the composite is cured at 94° C. to ensure the removal of the water content. Lower temperatures might be possible as long as sufficient water is removed from the structured sorbent after printing. The sorption capacity after activation at 120° C. increases with 433% when activated carbon is combined with the potassium silicate solution in comparison with the theoretical expected CO₂ uptake, see FIG. 13. Furthermore, the potassium silicate may also increase the CO₂ uptake when combined with other adsorbents. In some cases, the increase may be limited due to hydrophilicity of the surface.

It will be appreciated that the structure according to of the present disclosure can be employed for various applications. For example, the areas may be broadly divided into energy production and industrial emissions from chemical and materials processes. Regarding energy production there is contemplated herein the removal of carbon dioxide found in fuel gas produced from electricity generation (for example, steam boilers and combined cycle gas turbines) and steam production for industrial purposes (for example, steam heat and steam turbine drives). Large volumes of hydrocarbon fuel sources, such as coal, petroleum liquids and natural gas, are burned to produce heat and power. The combustion of hydrocarbons with air results in the release of carbon dioxide as a constituent of fuel gas into the atmosphere. Illustratively, fuel gas from combustion of coal may contain around 15% (by volume) carbon dioxide along with water vapor, nitrogen and other components. While still significant, slightly lower carbon dioxide levels may generally be contained in fuel gas from combustion of petroleum liquids and natural gas as a result of their chemical makeup.

Another broad energy production area of applicability of the subject invention is the removal of carbon dioxide from natural gas and produced gas. As appreciated by those skilled in the art, natural gas as it is removed from the well may contain varying amounts of carbon dioxide depending upon the well and the methods of enhancing natural gas production. It may often be desirable to reduce the amount of carbon dioxide from the raw natural gas, for example, as a way of meeting heat content specifications.

Another example of applicability of the present disclosure is upgrading of biogas into biomethane.

Although the procedures of for example the methods and processes described herein may be described in a particular order for ease of description, unless the context dictates otherwise, various procedures may be reordered, added, and/or omitted in accordance with various embodiments. Furthermore, the procedures described with respect to one method or process may be incorporated within other described methods or processes. Likewise, system components described according to a particular structural architecture and/or with respect to one system may be organized in alternative structural architectures and/or incorporated within other described systems. Therefore, while various embodiments are described with or without certain features for ease of description and to illustrate exemplary aspects of those embodiments, the various components and/or features described herein with respect to a particular embodiment can be substituted, added and/or subtracted from among other described embodiments, unless the context dictates otherwise.

The terms “first”, “second”, and the like, as used herein do not denote any order, quantity, or importance, but rather are used to distinguish one element from another.

It will be appreciated that the extruded filament may also be known in the art as a strut, fibre/fiber, rod, raster, and other terms.

It will be appreciated that the layer thickness can be seen as a layer height or slice thickness. It represents a z-increment when 3D printing the porous structure.

Herein, the present disclosure is described with reference to specific examples of embodiments of the present disclosure. It will, however, be evident that various modifications, variations, alternatives and changes may be made therein, without departing from the essence of the present disclosure. For the purpose of clarity and a concise description, features are described herein as part of the same or separate embodiments, however, alternative embodiments having combinations of all or some of the features described in these separate embodiments are also envisaged and understood to fall within the framework of the present disclosure as outlined by the claims. The specifications, figures and examples are, accordingly, to be regarded in an illustrative sense rather than in a restrictive sense. The present disclosure is intended to embrace all alternatives, modifications and variations which fall within the scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A method of making a three-dimensional monolithic carbon dioxide capture structure, the method comprising:
providing a first material, wherein the first material is a sorbent material comprising a carbon-based sorbent material;
providing a second material, wherein the second material is an inorganic binder material including potassium silicate;
providing a solvent;
mixing the first material, the second material and the solvent to produce a sorbent mixture;
building a monolithic three-dimensional porous structure using the sorbent mixture as building material; and
treating the monolithic three-dimensional porous structure so as to obtain the carbon dioxide capture structure;
wherein treating the monolithic three-dimensional porous structure comprises drying the monolithic three-dimensional porous structure at a temperature of at most 150° C.

2. The method according to claim 1, wherein the potassium silicate binder material is a solution or dispersion of potassium silicate in a liquid.

3. The method according to claim 1, wherein the potassium silicate binder material comprises oxides and hydroxides of K and Si with a molar ratio of Si:K between 1:1 and 5:1.

4. The method according to claim 1, wherein the potassium silicate binder material contains trace elements selected from one or more of Na, Li, Ca, Mg, Fe, and Al silicates.

5. The method according to claim 4, wherein the (trace element):K weight ratio is smaller than 2.5:100.

6. The method according to claim 1, wherein the first material and second material have a weight ratio in a range from about 0.8:0.2 to about 0.2:0.8, based on dry weight.

7. The method according to claim 1, wherein the building material comprises 10 to 80 wt. % of binder material, based on dry weight.

8. The method according to claim 1, wherein the binder material comprises at least 60 wt.% of potassium silicate, based on dry weight.

9. The method according to claim 1, wherein the monolithic three-dimensional porous structure is dried at a temperature between 40° C. and 150° C.

10. The method according to claim 1, wherein the sorbent material comprises between 0 and 25 wt. % based on dry weight of a further sorbent material, selected from one or more of a zeolite sorbent material, a silica-based sorbent material, an alumina-based sorbent material, a clay sorbent material, an organic polymer or resin sorbent material, or a metal organic framework sorbent material.

11. The method according to claim 1, wherein the carbon-based sorbent material includes one or more of an activated carbon, activated coke, activated charcoal, activated carbon fibers, biochars, or chars.

12. The method according to claim 1, wherein the three-dimensional monolithic carbon dioxide capture structure comprises a three-dimensional porous arrangement of the building material.

13. The method according to claim 1, wherein the three-dimensional monolithic carbon dioxide capture structure is produced by deposition of interconnected filaments of building material at a distance from each other, wherein the filaments are deposited in a plurality of stacked consecutive layers, wherein the filaments of the consecutive layers are connected to one another to obtain a porous arrangement with intra-structure pores formed between filaments.

14. The method according to claim 13, wherein the three-dimensional monolithic carbon dioxide capture structure is produced by 3D-printing employing extrusion of filaments of a viscous paste of the building material and deposition the filaments in a three-dimensional arrangement.

15. The method according to claim 1, wherein the three-dimensional monolithic carbon dioxide capture structure is produced by extrusion of the sorbent mixture.

16. A method for removing carbon dioxide from a gas or fluid mixture, the method comprising:
bringing the gas or fluid mixture in contact with a carbon dioxide capture structure; and
capturing at least a portion of the carbon dioxide in the gas or fluid mixture in the carbon dioxide capture structure;
wherein the carbon dioxide capture structure has a monolithic three-dimensional shape, the structure being porous with interconnected pores accessible from an exterior side of the structure, wherein the structure is made of a building material comprising a first material and a second material, wherein the first material comprises a carbon based sorbent material and wherein the second material is an inorganic binder material including potassium silicate, wherein the carbon dioxide capture structure is obtained using the method according to claim 1.

17. The method of claim 16, wherein one or more successive cycles are performed, each cycle involving an adsorption step and a subsequent desorption step, wherein carbon dioxide in the gas or fluid mixture is captured in the carbon dioxide capture structure in the adsorption step, and wherein the carbon dioxide captured in the carbon dioxide capture structure is released in the desorption step, wherein the desorption step is carried out at room temperature, and wherein the adsorption step is carried out at an absolute pressure in a range of 0.01 to 35 bar, and wherein the desorption step is carried out at an absolute pressure in a range of 20 mbar to 1 bar.

18. The method of claim 1, wherein the solvent is a water-based liquid, an alcohol, or a water-alcohol mixture.

19. The method of claim 18, wherein the solvent is water.

20. The method of claim 1, wherein the monolithic three-dimensional porous structure is dried at a temperature between 60° C. and 120° C.
